(19) United States
(12) Patent Application Publication
(10) Pub. No.: US 2013/0234931 A1
(43) Pub. Date: Sep. 12, 2013

(54) USER INTERFACE FOR GESTURE-BASED CONTROL INPUT AND RELATED METHOD

(71) Applicant: TEKNOLOGIAN TUTKIMUSKESKUS VTT, Espoo (FI)

(72) Inventors: Antti KERANEN, Littoinen (FI); Mikko HEIKKINEN, Littoinen (FI)

(73) Assignee: Teknologian tutkimuskeskus VTT, Espoo (FI)

(21) Appl. No.: 13/784,896

(22) Filed: Mar. 5, 2013

(30) Foreign Application Priority Data
Mar. 6, 2012 (GB) GB1203890.7

(51) Int. Cl. G06F 3/01

(52) U.S. Cl. CPC G06F 3/017
USPC 345/156; 29/592.1

(57) ABSTRACT

An electronic device for visualizing data and receiving related gesture-based control input from a user, configured to obtain digital image data utilizing a number of camera entities and to derive the control input on the basis of the image data, the electronic device including a display panel for displaying data to a user, and at least one protective element integrated with the display panel and including, as disposed at the periphery region around the active area of the display panel, the number of camera entities substantially embedded therein, the protective element including material that is optically substantially transparent relative to the predetermined reception wavelengths of the optically sensitive areas of the camera entities and substantially covers the sensitive areas, the camera entities in the protective element to span at least partially overlapping fields of view substantially in front of the display panel. A corresponding method of manufacture is presented.

### FIELD OF THE INVENTION

Generally the present invention concerns electronic devices and related user interfaces. Particularly, however not exclusively, the invention pertains to UIs (user interface) for gesture-based control incorporating optical sensing technology.

### BACKGROUND

User interfaces (UI) of electronic devices such as computers including desktop, laptop and palmtop devices have developed tremendously since the advent of the era of modern computing. Simple switches, buttons, and knobs have been in many cases replaced by keyboard, keypad, mouse, speech recognition input, touch display and related UI means like touchpad. Such more modern UI alternatives can provide the users of the associated devices with somewhat bearable user experience after a typically extensive adoption period.

In particular, touch displays undoubtedly form the ‘de facto’ UI of modern smart-phones, tablets and supplementary UI of many desktop computers as well. The touch displays may generally apply of a number of different technologies for implementing the touch-sensitive functionality. Among various other potential options, e.g. capacitive, resistive, infrared, optical imaging (camera-based), FTIR (frustrated total internal reflection), acoustic, and hybrid solutions are feasible. Despite of the underlying technological solution, basically all touch displays have the same basic goal of detecting the user's finger and/or stylus on a touch-sensitive surface, and depending on the location and optionally pressure of the touch, to control the linked functionality of the host device accordingly.

Even though the learning curve for more or less comprehensive utilization of touch displays is certainly fast if compared to the average time span required for mastering classic keyboards and typewriting in general, it is still far from perfect from the standpoint of truly natural expression.

Humans learn at very early age to communicate with gestures such as hand gestures. However, traditional touch screens are only capable of capturing very limited kind of gestures. Such gestures have to directly interact with a predetermined touch-sensitive surface of the host device as mentioned hereinabove in order to be registered by the touch display.

To provide additional degrees of freedom to the input acquisition with more intuitive natural feel, gesture-based UIs have been suggested incorporating means to detect e.g. hand gestures, not (only) against a predetermined surface, but ‘drawn’ in a suitable medium, typically air, so that the means can register the movements associated with the gestures and convert them into control input. Different sensors such as cameras have been typically positioned relative to the host device, usually a display thereof, so as to capture the gestures performed within a predetermined space in front of it.

Nevertheless, gesture UIs are still not perfect either. They certainly offer more natural and versatile control means to the user but are often somewhat pricey to implement and manufacture, take a considerable amount of space in the end product or use arrangement and add to the overall complexity of the system without forgetting the induced additional weight, which must be thus taken into account in the very beginning of the R&D project. They may also consume surprising amount of extra power e.g. in the context of mobile devices. Many sensors utilized in the suggested gesture UIs are prone to breakage due to sensitivity to environmental factors such as temperature, humidity, external impacts and dust.

### SUMMARY OF THE INVENTION

The objective of the embodiments of the present invention is to at least alleviate one or more of the aforesaid drawbacks evident in the prior art arrangements particularly in the context of gesture UI arrangements. The objective is generally achieved with a device and a corresponding method of manufacture in accordance with the present invention. The device may be utilized for 3D gesture tracking and position tracking as well as a technological implementation alternative to more conventional 2D touch displays.

In accordance with one aspect of the present invention an electronic device for visualizing data and receiving related gesture-based control input from a user is configured to obtain digital image data utilizing a number of camera entities and to derive, through the utilization of a processing entity, the control input on the basis of the image data preferably incorporating detection of objects, such as finger or hand of a user, and tracking their position, said electronic device comprising
a display panel for displaying data to a user, and
at least one protective element integrated with the display panel and comprising, as disposed at the periphery region around the active area of the display panel, said number of camera entities embedded in the material of the protective element, the material being optically substantially transparent relative to the predetermined reception wavelengths of the optically sensitive areas of the camera entities and substantially covering the sensitive areas, and wherein the camera entities have been configured in the protective element to span at least partially overlapping fields of view substantially in front of the display panel.

In one embodiment, the protective element comprises a display overlay element such as overlay sheet or film including optically transmissive material that preferably covers the active, light-emitting area of the display panel and also the periphery region supplied with camera entities. The protective element may thus act as a screen cover in this embodiment. The overlay may comprise plastic and/or glass, for instance. The overlay may be provided with desired properties in terms of transparency, hardness, scratch-resistance, anti-glare treatment, filtering properties, etc.

Preferably the overlay is also optically substantially transparent relative to the predetermined wavelengths such as visible light to be emitted by the display panel for enabling flawless viewing experience, or at least the portion of the overlay covering the emissive area of the panel is preferably such. The display panel may be at least partially provided with a multi-part or multi-layer overlay containing e.g. multiple overlay layers, such as a thin substrate for accommodating elements such as camera entities and a thicker protective outer layer such as a front glass or plastic layer in immediate contact with the environment. Therefore, the embedded camera entities may be substantially sandwiched between the layers. The layers are preferably attached, optionally by lamination, together.

Regarding more specific material examples, the overlay, or the protective element in general, may include e.g. PC (polycarbonate), PMMA (polymethyl methacrylate), PA (polyamide, nylon), COC (cyclo olefin copolymer), and/or COP (cyclo olefin polymer). A piece of any aforesaid and/or other material, e.g. a sheet or film with desired dimensions, may be positioned and secured onto the display to establish the protective overlay thereon. The piece may contain a number of recesses, cavities, or holes for accommodating various elements such as the camera entities, electronic circuits, conductors, etc.

In one other, either supplementary or alternative, embodiment the protective element comprises a frame structure surrounding the display panel or at least a portion thereof. The frame preferably protects the display panel from the sides, optionally from behind as well, and optionally acts as at least a portion of the housing thereof.

In various embodiments, the protective element, such as a transparent overlay, may have been practically unremovably integrated with the display panel. Alternatively, the protective element may have been releasably integrated with the display panel either directly or via an intermediate element such as a common housing. Different lamination, molding, gluing and e.g. mechanical fixing elements (screws, bolts, hooks etc.) may have been applied for the desired type and degree of integration.

In a further, either supplementary or alternative, embodiment at least one camera entity comprises an image sensor, such as CCD (Charge-Coupled Device), CMOS (Complementary Metal Oxide Semiconductor), or a hybrid sensor. The sensor is provided with a light-sensitive (optically sensitive) area for capturing light and turning it into electrical signal.

In a further, either supplementary or alternative, embodiment at least one camera entity comprises a wafer level camera (WLC) device. WLC may comprise wafer level parts bonded together. E.g. micro-optic element(s) such as lenses, apertures, and/or related carriers, and a sensor may have been stacked to form at least part of a WLC. Nanometer range structures may be present.

Further, the camera entities may be provided with support electronics and/or other electronics such as conductors, electrical components, chips, etc. optionally also embedded in the protective element. They may be printed on a substrate by utilizing a selected printing technique, or attached as ready-made entities, e.g. SMT (surface-mount technology) and/or flip chip entities, to the substrate by e.g. glue or other adhesive.

Yet in a further, either supplementary or alternative, embodiment there is a plurality of camera entities in said number. They may be symmetrically disposed relative to the display panel, for example.

Still in a further, either supplementary or alternative, embodiment at least one camera entity is located on a substrate, such as flexible plastic film, upon which the optically substantially transparent material of the protective element has been provided by over-molding or lamination, for example. The substrate may be common to multiple camera entities and optional other elements.

In particular, the substrate material may include e.g. PET (polyethylene terephthalate), PC (polycarbonate), PEN (polyethylene naphthalate), PI (polyimide), LCP (liquid crystal polymer), PE (polyethylene), and/or PP (polypropylene). However, other materials may be alternatively used.

The required degree of transparency of the utilized materials depends on the particular use case. In one embodiment the preferred transmittance in relation to predetermined wavelengths of light (e.g. infrared and/or visible) to be captured by the camera entities or emitted by the active area of the display panel may fall within range from about 80% to about 95%, for instance.

In a further, either supplementary or alternative, embodiment the device includes at least one light emitter for illuminating the potential imaging target such as a finger or a hand of a user hovering in front of the display panel. The emitted light may be then at least partially reflected to camera entities capable of capturing it and forming a related image. The wavelengths emitted may belong to at least one radiation wavelength category selected from the group consisting of: ultraviolet light, visible light and infrared light. Optionally different emitters may be configured for different emission characteristics. In many cases, imaging quality may be enhanced through the use of emitters as sole/additional (in addition to e.g. sunlight or generally ambient light) illumination sources.

The emitters may include optoelectronic components such as LEDs (light emitting diode) or OLEDs (organic LED), for example. Such elements may be formed utilizing a feasible printed electronics technology. Alternatively or additionally, SMT technology may be applied.

In various embodiments of the present invention the camera entities may be configured to image wavelengths belonging to at least one radiation wavelength category selected from the group consisting of: ultraviolet light, visible light and infrared light. Optionally different camera entities may be configured for mutually different light reception. With reference to the paragraphs above, if dedicated emitters are utilized for lighting up the target space in front of the display panel, wavelength-matching camera entities may be exploited for imaging the objects within the space on the basis of reflected light.

In some embodiments, the electronic device is configured to apply the camera entities and associated image data to implement a touch display such that the fields of view of the cameras are selected to include the predetermined surface areas of the touch panel structure, e.g. outmost overlay thereof, whereupon the touch actions and optionally other gestures, e.g. sliding actions, thereon by an object such as a finger or a stylus, for instance, can be detected. The location and optionally nature (e.g. duration and/or pressure estimated on the size of contact area, for example) of the touch may be applied according to predetermined rules in converting the touch into control input.

In some, either supplementary or alternative, embodiments the electronic device is configured to apply the camera entities and associated image data to implement touchless, preferably 3D, gesture tracking. The camera entities are aligned so as to image objects in front of the display panel. The monitored space (dimensions) may be case-specifically determined. In case multiple cameras are used, preferably their angles of view at least partially overlap to enable precise and/or 3D location determination of objects present in camera views.

Optionally, the suggested technique for touchless gesture tracking may be supplemented in the electronic device with alternative technology-based touch display solution for touch (contact) monitoring. The touch display may be based on capacitive, resistive, infrared, FTIR, acoustic, and hybrid technology, for example. In supplementary optical solutions (infrared, FTIR, etc.) the applied emitters may include LEDs or OLEDs and the detectors equally suitable optoelectronic elements like photodiodes or phototransistors, for example.

In another aspect of the present invention, a method for manufacturing an electronic device for user input acquisition, such as a 3D gesture UI, comprises:
providing a display panel for displaying data, and
integrating at least one protective element with the display panel, wherein a number of camera entities are embedded in the material of the protective element as disposed at the periphery region around the active area of the display panel, the material being optically substantially transparent relative to the predetermined reception wavelengths of the optically sensitive areas of the camera entities and substantially covering the sensitive areas, and wherein the camera entities are configured in the protective element to span at least partially overlapping fields of view substantially in front of the display panel.

In one embodiment the protective element may contain several portions such as layers attached together. E.g. electrical wiring, such as conductors, may be printed or otherwise formed on a flex film substrate or other type of flex or rigid substrate after which other elements such as the camera entities and optionally control electronics such as processing devices may be attached. Then a further layer such as a rigid, potentially scratch-resistant, glass or plastic sheet may be laminated or otherwise arranged onto the film or other substrate.

The previously presented considerations concerning the various embodiments of the device may be flexibly applied to the embodiments of the method mutatis mutandis and vice versa, as being appreciated by a skilled person.

As briefly reviewed hereinbefore, the utility of the different aspects of the present invention arises from a plurality of issues depending on each particular embodiment. The manufacturing costs for producing the UI in accordance with the present invention to enable optical imaging—based, preferably touchless, gesture detection may be kept low due to rather extensive use of affordable and easily obtainable materials, components, and process technology. The provided pattern recognition and/or stereoscopy—based embedded UI is scalable from hand-held mobile devices and game consoles to larger applications. The feasible process technology also provides for rapid industrial scale manufacturing of the arrangement in addition to mere prototyping scenarios.

The arrangement may be kept thin, light, and energy conserving in order to suit most use scenarios with little modifications to the surrounding elements and designs. The obtained integration level is generally very high. The camera arrangement may also be combined with an existing display or device layout. The protective element may be made robust towards external impacts, depending on the used materials, in which case it also function as an optionally replaceable screen and/or side cover for the underlying display panel. The protective element may, in particular, comprise optically transmissive material that sufficiently passes the incident light through towards the cameras and optionally away from the possible emitters.

In some embodiments, the protective element or a portion thereof may be specifically configured for light guiding purposes. Yet, the UI suits particularly well various industrial applications including e.g. industrial automation/electronics control apparatuses, as it may provide hermetical (splash-proof) isolation from the hostile use environment with e.g. humid and/or dusty air.

The expression “a number of” may herein refer to any positive integer starting from one (1). The expression “a plurality of” may refer to any positive integer starting from two (2), respectively.

The terms “touchless” and “contactless” are used herein interchangeably.

Different embodiments of the present invention are also disclosed in the attached dependent claims.

### BRIEF DESCRIPTION OF THE RELATED DRAWINGS

Next, the embodiments of the present invention are more closely reviewed with reference to the attached drawings, wherein

FIG. 1 illustrates the basic concept of the present invention via two embodiments thereof.

FIG. 2 illustrates the concept of the present invention via one further embodiment thereof.

FIG. 3 depicts some functional aspects of the present invention.

FIG. 4 is a block diagram of one embodiment of an apparatus comprising the UI arrangement in accordance with the present invention.

FIG. 5 is a flow diagram disclosing an embodiment of a method in accordance with the present invention.

### DETAILED DESCRIPTION OF THE EMBODIMENTS

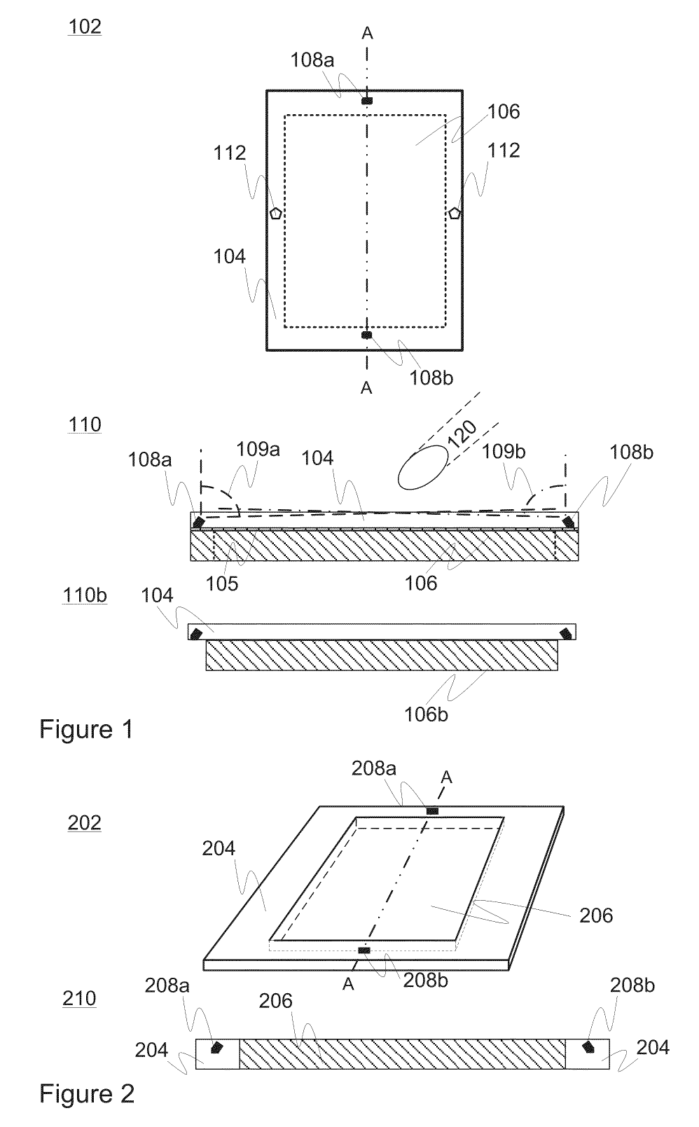

With reference to FIG. 1, a common front view 102 and two alternative cross-sectional side views 110, 110b (along line A-A) of the corresponding two alternative embodiments of the suggested electronic device are shown. The electronic device may comprise various additional elements, either integrated or separate, in addition to the disclosed ones. As being appreciated by skilled readers, also the configuration of the disclosed elements may differ from the explicitly depicted one depending on the requirements of each intended use scenario wherein the present invention may be capitalized.

The camera arrangement, which may be implemented as including an overlay structure 104, 105, or a ‘front glass’, for a display panel 106, 106b may comprise a substrate such as a transparent (flexible) film 105 for accommodating predetermined electronics including a number of camera entities 108a, 108b such as wafer-level cameras and optionally other components such as light emitters 112, conductors, control chips, memory, light-guiding elements or structures, light blocking elements or structures, etc. In the case of multiple cameras, they may mutually differ in terms of properties such as imaging wavelength, optics, sensor size, etc.

Integration may be performed such that at least one further, protective layer 104 is laminated, molded or otherwise disposed onto the electronics on the substrate 105, where the provided layer 104, or the material forming the layer, preferably adapts to the surface contours of the substrate 105 provided with the cameras 108a, 108b. Alternatively or additionally the layer 104 may contain pre-formed recesses for (enabling) accommodating elements on the substrate 105. Accordingly, the overlay structure 104, 105 at least partially embeds the cameras 108a, 108b and potentially other desired elements.

The layer 104 preferably covers and protects at least part of the underlying camera entities 108a, 108b, such as light-sensitive areas thereof, and optional other elements such as light emitters 112. Further advantageously, the layer 104 comprises optically substantially or at least sufficiently transparent material in view of the display panel 106, 106b (typically visible light), cameras (e.g. visible light and/or infrared), and optional light emitters. The substrate 105 and/or protective layer 104 may comprise multiple materials optionally arranged as layers, regions and/or subvolumes.

The overlay element(s) 104, 105 may be substantially flat or contain substantially flat portion(s). In some embodiments the overlay 104, 105 may be at least partially curved or contain curved shape(s) e.g. at the edges. Yet, the overlay 104, 105 may contain concave or convex shape(s), for instance.

The overlay 104, 105 may be disposed upon the display panel 106, 106b preferably fixedly. For instance, gluing, lamination, molding, or mechanical fixing means (screws, bolts, fingers, etc.) may be applied. The overlay 104, 105 protects the underlying display electronics and hides the camera entities 108a, 108b and optional other elements with a flat overall structure. An object 120, such as a finger, hovering above the obtained structure may be detected and tracked.

The display panel 106, 106b may include an LCD (liquid crystal display), LED (light-emitting diode) or plasma display, for instance. So-called flat display technologies such as the aforementioned LCD or LED are in typical applications preferred but in principle other technologies such as CRT (cathode ray tube) are feasible in the context of the present invention as well.

In various embodiments of the present invention, gestures to be detected may include at least one action selected from the group consisting of: touch, push, press, slide, multi-touch, circle gesture, sweep, finger mark, finger movement, wrist rotation, hand opening, hand closing, hitting, blocking, dodging, kicking, leg movement, body movement, eye blinking, head nodding, head movement, head rotation, and mouth movement.

The configuration of the camera entities 108a, 108b such as the number, type, positioning, and alignment thereof, may be determined according to use case—specific objectives. In the shown case two camera entities 108a, 108b with fields of view 109a, 109b, respectively, have been located on the opposite sides of the overlay area over the active area of the display panel 106 but the entities 108a, 108b could also be located in some alternative manner, e.g. on the same side of the display area, and/or the number of camera entities 108a, 108b could be varied depending on the embodiment. Through increase of the number of cameras, more accurate gesture tracking results and/or larger overall field of view may be generally obtained, but the complexity and size of the solution respectively increases, and vice versa.

The shape of the overlay, e.g. the top layer 104 and the substrate 105, may be defined on the basis of the used manufacturing method and desired target shape(s). The illustrated, however merely exemplary, overlay arrangement and/or elements thereof has/have substantially a rectangular (cuboid), substantially flat, shape, which works particularly well with roll-to-roll manufacturing methods and with typical display applications, but also e.g. round(ed) and/or thicker shapes are possible and achievable via proper cutting, for instance.

In the embodiment shown at 110, the overlay 104, 105 covers the whole top area of the display panel 106 including the predetermined active center region and the border areas (vertical dotted lines represent the division). The embedded camera entities 108a, 108b and preferably also other elements typically not being sufficiently transparent from the standpoint of flawless light emission from the display (active region) through the overlay 104, 105, are located at areas on top of passive, non-emissive, portions of the display panel 106 to avoid picture distortion and degradation.

At 110b disclosing an alternative solution, the overlay layer 104 (substrate layer not shown but being still an option) extends over the borders of the underlying display panel 106b, whereupon at least the overhang portions may be provided with camera entities and other elements without causing noticeable artifacts to the display signal even if no passive region is present at the border areas of the display panel 106b.

FIG. 2 illustrates, via the axonometric view at 202, a further embodiment in which the protective element 204 incorporating the camera entities 208a, 208b constitutes at least part of the frame structure, such as a rectangular structure having an opening in the middle, surrounding the display panel 206. The display panel 206 may still be provided with overlay layer(s) that are optionally also attached to the frame 204 and optionally cover at least portion thereof. A substrate layer as described above may again be utilized for the camera entities 208a, 208b and optional other elements (not shown).

At 210, a cross-sectional (A-A) side view is shown. The frame 204 generally comprising e.g. glass and/or plastic material may also include control and analysis hardware such as processing and memory chips, communication hardware, etc. in addition to the camera entities 208a, 208b. The display panel 206 may comprise a protective overlay of its own and/or a shared overlay also extending over the frame 204 could be used (not shown).

The frame 204 may be substantially flat or contain substantially flat portion(s). In some embodiments, the frame 204 may be at least partially curved or contain curved shape(s) e.g. at the edges. Yet, the frame 204 may contain concave or convex shape(s), for instance. The front surface of the frame 204 and the front surface of the panel (or panel overlay) 206 may be substantially at the same level (illustrated case), or the frame 204 may be configured to protrude from the level of the panel surface or remain below it.

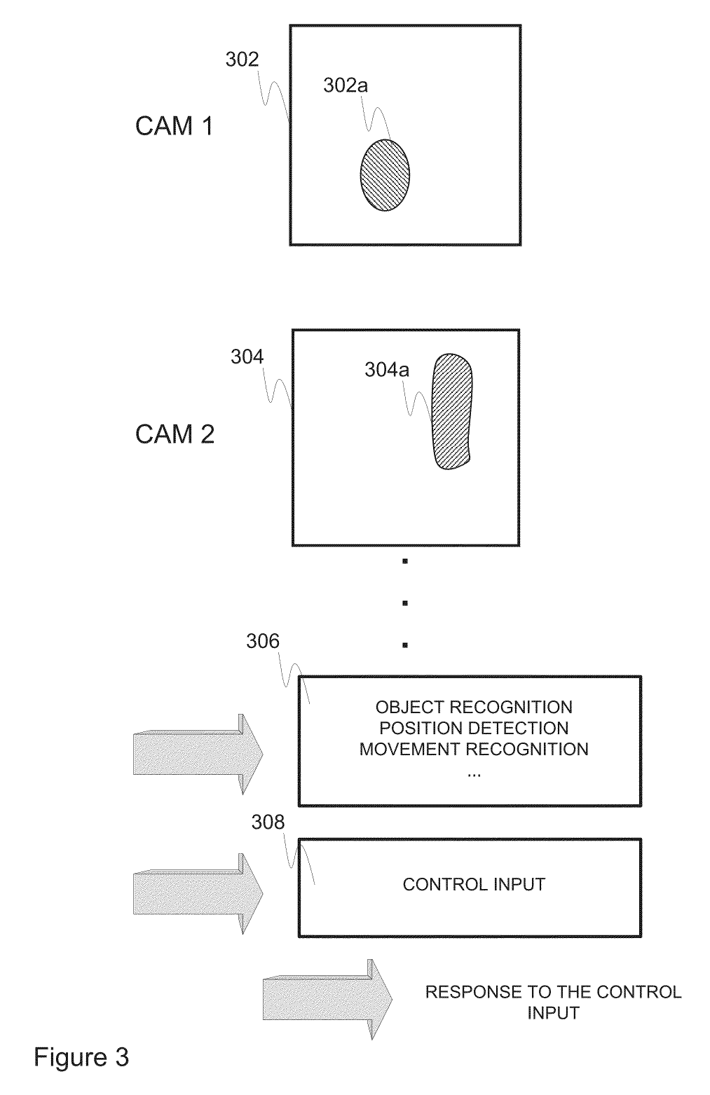

FIG. 3 depicts various functional aspects of the present invention. A number of cameras are configured to provide corresponding image data 302, 304 indicative of object(s) 302a, 304a in their preferably overlapping fields of view, i.e. the same object 302a, 304a may be detectable in the temporally matching image data of several cameras. Increasing the number of cameras may improve the detection results such as accuracy by the increased redundancy, for example.

As the object(s) 302a, 304a are present in the image data provided by cameras the position/alignment of which is known (by calibration, for instance), the desired applicable pattern recognition, stereoscopy and/or other data analysis methods 306 may be executed to generally detect the presence of the object(s) (e.g. contour or edge detection), recognize the object(s) and/or their features, and trace the location and movements thereof, for instance. The analysis results may be at least partially converted into control input 308 according predetermined, e.g. application-specific, control rules. The electronic device and/or external device whereto the control input is forwarded may then act, i.e. respond, accordingly.

The suggested solution may be applied to implement a touch display, wherein gestures are tracked relative to a reference plane (in camera view) such as the surface of the display panel structure potentially including the aforementioned overlay. Alternatively or additionally, 3D tracking of touchless gestures performed in front of the display and/or elsewhere within the camera view may be implemented.

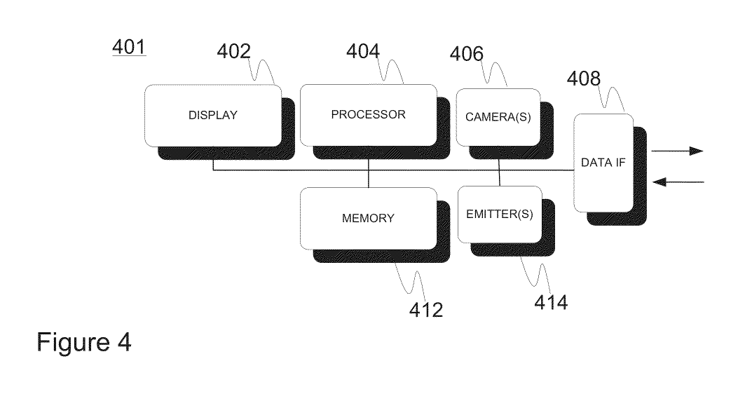

FIG. 4 is a general block diagram of one embodiment of a device comprising the UI arrangement in accordance with the present invention.

The device may include or constitute a mobile terminal, a PDA (personal digital assistant), a control device for industrial or other applications, a specific- or multi-purpose computer (desktop/laptop/palmtop), etc. As being clear to a skilled person, various elements of the device 401 may be directly integrated in the same housing or provided at least with functional connectivity, e.g. wired or wireless connectivity, with each other.

One potential, if not elementary, element that is included in the apparatus is memory 412, which may be divided between one or more physical memory chips and/or cards, may comprise necessary code, e.g. in a form of a computer program/application, for enabling the control and operation of the apparatus, analysis of image data, and provision of the related control data. The memory 412 may include e.g. ROM (read only memory) or RAM—type (random access memory) implementations. The memory 412 may further refer to an advantageously detachable memory card/stick, a floppy disc, an optical disc, such as a CD-ROM, or a fixed/removable hard drive.

A processing element 404, e.g. at least one processing/controlling unit such as a microprocessor, a DSP (digital signal processor), a micro-controller or programmable logic chip(s), optionally comprising a plurality of co-operating or parallel (sub-)units, may be needed for the actual execution of the application code that may be stored in memory 406 as mentioned above.

A display 402 and possible traditional control input means, such as keys, buttons, knobs, voice control interface, sliders, rocker switches, etc. may provide the user of the device 401 with data visualization means and control input means in connection with the display panel 402. Nevertheless, a number of camera entities 406 are utilized for implementing the gesture UI in accordance with the present invention.

Data interface 408, e.g. a wireless transceiver (GSM (Global System for Mobile Communications), UMTS (Universal Mobile Telecommunications System), WLAN (Wireless Local Area Network), Bluetooth, infrared, etc), and/or an interface for a fixed/wired connection, such as an USB (Universal Serial Bus) port, a LAN (e.g. Ethernet) interface, or Firewire-compliant (e.g. IEEE 1394) interface, is typically required for communication with other devices.

The device may include various supplementary elements 414 such as light emitters for enhancing the function of the camera UI, for instance. It is self-evident that further functionalities may be added to the device and the aforesaid functionalities may be modified depending on each particular embodiment.

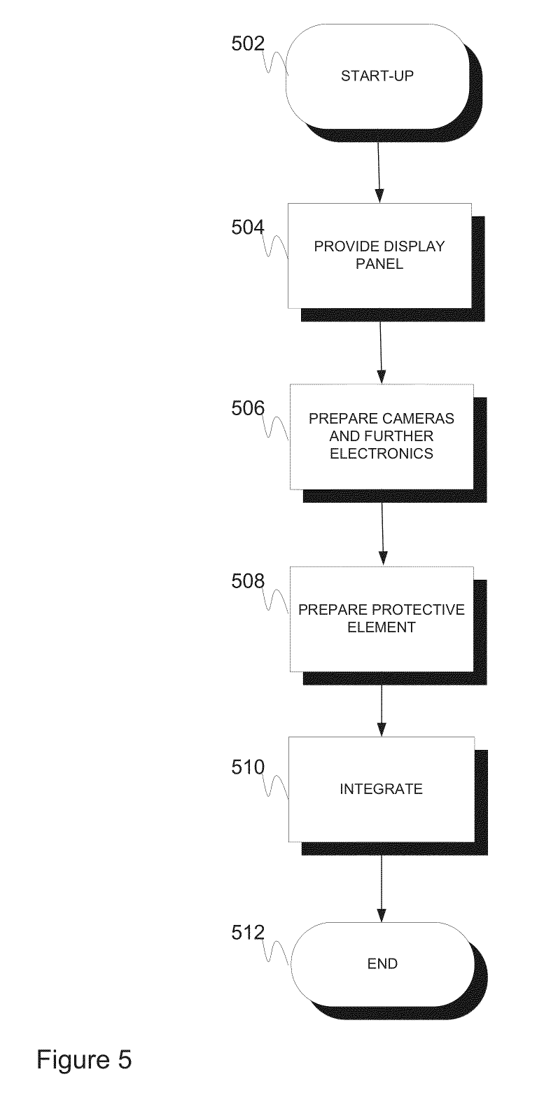

FIG. 5 is a flow diagram of one feasible embodiment for manufacturing the device and related UI arrangement of the present invention.

At 502, referring to a start-up phase, the necessary tasks such as material, component and tools selection and acquisition take place. In determining the suitable cameras, emitters and other elements/electronics, specific care must be taken that the individual elements and material selections work together and survive the selected manufacturing process of the overall arrangement, which is naturally preferably checked up-front on the basis of the manufacturing process vs. component data sheets, or by analyzing the produced prototypes, for example.

At 504, a display panel is provided. The panel incorporates the necessary electronics for providing the desired control, lighting and image establishment elements.

The panel may be manufactured in connection with the rest of the device or provided as at least partially ready-made element. The panel may include a number of layers some of which have electrical and/or optical function and some of which are mainly protective, for example. In some embodiments, the device could include multiple display panels optionally located adjacent to each other.

At 506, a number of camera entities and associated elements are prepared. For example, at least one substrate layer such as a sheet or film may be first provided with electronics such as conductors, cameras, emitters, and desired control circuitry. The associated chips and other entities may be provided onto the substrate by a flip-chip bonding apparatus or constructed utilizing an inkjet printer, for example.

The used substrate(s) may include, for example, polymers such as a PET or PC film. An applicable substrate shall be generally selected such that the desired flexibility, robustness, and other requirements like adhesion properties in view of the electronics and the adjacent materials, or e.g. in view of available manufacturing techniques, are met.

The selected substrate may also be preconditioned prior to and/or during the illustrated processing phases. The substrate may be preconditioned to increase adhesion with other materials such as laminated, glued or injection-molded cover plastics, for example.

Electronic SMT components and circuits or (flip) chips may be attached to the target substrates by adhesive, such as an epoxy adhesive, for example. Both conductive (for enabling electrical contact) and non-conductive (for mere fixing) adhesives may be utilized. Such elements are preferably selected so as to withstand the pressure and temperature of the utilized protective element-establishing process such as lamination or injection over-molding process. Alternatively or additionally, the enclosing material layer may established by applying a sheet or film of suitable material, e.g. glass or plastic material, which is disposed onto the substrate and, for example, glued and/or otherwise fixed thereto. The materials, such as the materials utilized in the protective element, may include epoxy and/or sol-gel or corresponding, potentially molded, materials.

Electronic and optoelectronic elements including the light emitter(s) and camera entities and/or other detector(s) may be bonded with the substrate(s) by adhesive, for example. Accordingly, suitable printing technologies may be exploited. E.g. OLEDs may be printed on the substrate by an inkjet printer or other applicable device. Printing technologies are further described hereinlater.

At 508, at least one top protective layer, which may optionally also act as a carrier (substrate) for various components, may be arranged onto the substrate(s)/electronics aggregate by lamination or molding, for instance, to establish the protective element. At least part of the desired elements may be thus “immersed” in the protective element, for instance located in the recesses thereof, that encapsulates them. The protective element may indeed be a single- or multi-layer element depending on the embodiment. Yet, it may in some embodiments establish at least part of a display overlay and/or protective frame/edge thereof.

As a practical example, the top layer may comprise plastic material such as PC that is laminated, (over-)molded or otherwise disposed onto the substrate like a thermo-plastic polymer film, e.g. a PET film, having electronics such as camera entities already provided thereon. During molding, the substrate may be applied as an insert into the mold of the injection moulding apparatus so that the PET is cast upon the substrate. The provided material and the used attachment method shall be preferably selected such that the electronics on the substrate remain unharmed during the process, while the provided material is properly attached to the substrate and the optical properties thereof are as desired. Alternatively or additionally, the top layer may include glass.

Considering the process parameters and set-up, few further guidelines can be given as mere examples as being understood by the skilled persons. When the substrate is PET and the plastics to be, for example, over-molded thereon is PC, the temperature of the melted PC may be about 280 to 320° C. and mold temperature about 20 to 95° C., e.g. about 80° C. The used substrate (film) and the process parameters shall be preferably selected such that the substrate does not melt and remains substantially solid during the process. The substrate shall be positioned in the mold such that it remains properly fixed. Likewise, the preinstalled electronics shall be attached to the substrate such that they remain static during the molding.

The protective element may be ready-fitted to a host device (housing) at the factory or provided upon the display and coupled thereto later e.g. at a workshop only when needed. Especially in the latter case, the display panel may already contain some sort of protective outer layer, such as a front glass or plastic sheet, which may be left as is or processed/removed upon installation of the overlay in accordance with the present invention. For post-factory installment, the device may include necessary connectors and expansion slots for communication and e.g. power supply purposes.

At 510, the protective element comprising the cameras, optional other elements and material layers is indeed integrated with the display panel. In alternative solutions, the protective element could be directly constructed on the panel optionally in several phases such as layer at a time.

At 512, the method execution is ended. Further actions such as camera (image data) calibration may take place.

Generally, feasible techniques for providing printed electronics may include screen printing, rotary screen printing, gravure printing, flexography, ink-jet printing, tampo printing, etching (like with PWB-substrates, printed wiring board), transfer-laminating, thin-film deposition, etc. For instance, in the context of conductive pastes, silver-based PTF (Polymer Thick Film) paste could be utilized for screen printing the desired circuit design on the substrate. Also e.g. copper or carbon-based PTF pastes may be used. Alternatively, copper/aluminum layers may be obtained by etching. In a further alternative, conductive LTCC (low temperature co-fired ceramic) or HTCC (high temperature co-fired ceramic) pastes may be sintered onto the substrate. One shall take into account the properties of the substrate when selecting the material for conductors. For example, sintering temperature of LTCC pastes may be about 850 to 900° C., which may require using ceramic substrates. Further, silver/gold-based nanoparticle inks could be used for producing the conductors.

The paste/ink shall be preferably selected in connection with the printing technique and the substrate material because different printing techniques require different rheological properties from the used ink/paste, for instance. Further, different printing technologies provide varying amounts of ink/paste per time unit, which often affects the achievable conductivity figures.

The use of advantageously flexible materials preferably enables carrying out at least some of the method items by roll-to-roll methods, which may provide additional benefits time-, cost- and even space-wise considering e.g. transportation and storage. In roll-to-roll, or ‘reel-to-reel’, methods the desired elements, such as optical and/or electrical ones, may be deposited on a continuous ‘roll’ substrate, which may be both long and wide, advancing either in constant or dynamic speed from a source roll, or a plurality of source rolls, to a destination roll during the procedure. Thus the substrate may thus comprise multiple products that are to be cut separate later. The roll-to-roll manufacturing advantageously enables rapid and cost effective manufacturing of products also in accordance with the present invention. During the roll-to-roll process several material layers may be joined together ‘on the fly’, and the aforesaid elements such as electronics may be structured on them prior to, upon, or after the actual joining instant. The source layers and the resulting band-like aggregate entity may be further subjected to various treatments during the process. Layer thicknesses (thinner layers such as ‘films’ are generally preferred in facilitating roll-to-roll processing) and optionally also other properties should be selected so as to enable roll-to-roll processing to a preferred extent.

The scope of the invention is determined by the attached claims together with the equivalents thereof. The skilled persons will again appreciate the fact that the disclosed embodiments were constructed for illustrative purposes only, and the innovative fulcrum reviewed herein will cover further embodiments, embodiment combinations, variations and equivalents that better suit each particular use case of the invention. For instance, instead of a touch display, the suggested solution could be applied to implement a touch pad or some other gesture input device with no mandatory display-associated function.

1. An electronic device (102, 110, 110b, 202, 210, 401) for visualizing data and receiving related gesture-based control input from a user, configured to obtain digital image data (302, 304) utilizing a number of camera entities (108a, 108b, 208a, 208b, 406) and to derive the control input on the basis of the image data, said electronic device comprising
a display panel (106, 106b, 206, 402) for displaying data to a user, and
at least one protective element (104, 105, 204) integrated with the display panel and comprising, as disposed at the periphery region around the active area of the display panel, said number of camera entities substantially embedded therein, said protective element including material that is optically substantially transparent relative to predetermined reception wavelengths of the optically sensitive areas of the camera entities and substantially covers the sensitive areas, and wherein the camera entities have been configured in the protective element to span at least partially overlapping fields of view (109a, 109b) substantially in front of the display panel.

2. The device of claim 1, wherein the protective element comprises a display overlay (104, 105), such as a sheet or film, preferably covering the active light-emitting area of the display panel and further the periphery region supplied with camera entities, said overlay optionally comprising plastic and/or glass material.

3. The device of claim 1, wherein the protective element comprises a frame (204) surrounding the display panel or at least a portion thereof, said frame optionally comprising plastic and/or glass material.

4. The device of claim 1, wherein at least one camera entity comprises an image sensor, such as a CCD (Charge-Coupled Device), CMOS (Complementary Metal Oxide Semiconductor), or hybrid sensor.

5. The device of claim 1, wherein at least one camera entity comprises a wafer level camera (WLC) device.

6. The device of claim 1, wherein at least one camera entity is located on a substrate (105), such as a flexible plastic film, upon which the optically substantially transparent material has been provided optionally by over-molding or lamination.

7. The device of claim 1, comprising at least one light emitter (112, 414), such as LED (light-emitting diode) or OLED (organic LED), for illuminating predetermined region or direction substantially in front of the display panel.

8. The device of claim 1, configured to derive the control input through 3D tracking of touchless gestures incorporating utilization of said number of camera entities and related image data.

9. The device of claim 1, configured to implement a touch display through the utilization of said number of camera entities and related image data indicative of gestures, such as pushing or pressing actions by an object, relative to a reference plane.

10. A mobile terminal comprising the device of claim 1.

11. A desktop or laptop computer comprising the device of claim 1.

12. A tablet computer comprising the device of claim 1.

13. A television or a monitor comprising the device of claim 1.

14. (canceled)

15. (canceled)

16. A method for manufacturing an electronic device for user input acquisition, such as a 3D gesture UI, comprising:
providing a display panel for displaying data (504), and
integrating at least one protective element with the display panel (506, 508, 510), wherein a number of camera entities are embedded in the protective element as disposed at the periphery region around the active area of the display panel, the protective element including material that is optically substantially transparent relative to the predetermined reception wavelengths of the optically sensitive areas of the camera entities and substantially covers the sensitive areas, and wherein the camera entities are configured in the protective element to span at least partially overlapping fields of view substantially in front of the display panel.
